(19) United States
(12) Patent Application Publication
(10) Pub. No.: US 2025/0138539 A1
(43) Pub. Date: May 1, 2025

(54) PROTECTING ROBOTIC BEE FROM THREATS BY DYNAMICALLY GENERATING IMPULSE FORCE

(71) Applicant: International Business Machines Corporation, Armonk, NY (US)

(72) Inventors: Sarbajit K. Rakshit, Kolkata (IN); Manikandan Padmanaban, Chennai (IN); Jagabondhu Hazra, Bangalore (IN)

(21) Appl. No.: 18/383,841

(22) Filed: Oct. 25, 2023

(51) Int. Cl. G05D 1/08; G05D 1/10; G06T 7/00; G06V 10/82; G06V 20/10; G06V 20/17

(52) U.S. Cl. CPC G05D 1/0816; G06T 7/0012; G06V 10/82; G06V 20/17; G06V 20/188; G06T 2207/10032; G06T 2207/20081; G06T 2207/20084; G06T 2207/30188

(57) ABSTRACT

Described are techniques for self-protecting a robotic bee. An unbalanced operation of the robotic bee being performed on a plant that is caused by a threat is detected. Furthermore, the type of plant involved in the detected unbalanced operation is determined. Additionally, the level of threat to the robotic bee in not being able to complete its requested operation is classified based on the received images of the operation of the robotic bee being performed on the plant. Based on the type of plant and the classified level of threat, an amount of an impulse force to be generated by the robotic bee is determined using a trained reinforcement learning model. An impulse force is a fast-acting force which is utilized by the robotic bee to move away from the area causing the threat. Such an amount of impulse force is instructed to the robotic bee to be generated.

### TECHNICAL FIELD

The present disclosure relates generally to robotic bees, and more particularly to protecting robotic bees from threats by dynamically generating an impulse force.

### BACKGROUND

Robotic bees, or mechanical bees, are machines designed to do the work of actual bees, like pollinating plants, as well as monitor the health of bee hives. They are used to increase productivity in the agriculture industry, particularly as the global bee population grows more fragile.

### SUMMARY

In one embodiment of the present disclosure, a computer-implemented method for self-protecting a robotic bee comprises detecting an unbalanced operation of the robotic bee being performed on a plant. The method further comprises determining a type of the plant using image data of the plant in response to the detected unbalanced operation of the robotic bee. The method additionally comprises classifying a level of threat of the robotic bee not being able to complete its requested operation based on received images of the operation of the robotic bee in response to the detected unbalanced operation of the robotic bee. Furthermore, the method comprises instructing the robotic bee to generate an impulse force based on the type of the plant and the classified level of threat.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 illustrates robotic bee controller and/or robotic bee detecting a threat in preventing the robotic bee from accomplishing its requested operation in accordance with an embodiment of the present disclosure;

FIGS. 3A-3B illustrate a robotic bee generating an impulse force to avoid or respond to the detected threat in accordance with an embodiment of the present disclosure;

FIG. 4 illustrates an external view of robotic bee in accordance with an embodiment of the present disclosure;

FIG. 5 illustrates the internal components of robotic bee in accordance with an embodiment of the present disclosure;

FIG. 6 is a diagram of the software components used by the robotic bee controller to protect robotic bee from threats by dynamically generating an impulse force in accordance with an embodiment of the present disclosure;

FIG. 7 illustrates an embodiment of the present disclosure of the hardware configuration of the robotic bee controller which is representative of a hardware environment for practicing the present disclosure;

FIG. 8 is a flowchart of a method for protecting robotic bees from threats in preventing them from completing their requested operations by dynamically generating an impulse force in accordance with an embodiment of the present disclosure; and

FIG. 9 is a flowchart of a method for training a reinforcement learning model for determining an amount of impulse force to be generated by the robotic bee to avoid or respond to the threat in preventing the robotic bee from completing its requested operation in accordance with an embodiment of the present disclosure.

### DETAILED DESCRIPTION

As stated above, robotic bees, or mechanical bees, are machines designed to do the work of actual bees, like pollinating plants, as well as monitor the health of bee hives. They are used to increase productivity in the agriculture industry, particularly as the global bee population grows more fragile.

A robotic bee is designed to automate the liquid-mediated pollen delivery process. For example, a robotic bee may be equipped with an image recognition system to detect suitable recipient flowers for cross pollination. A robotic bee may also be equipped to carry a cartridge loaded with liquid pollen solution. Once a suitable recipient flower is identified, the robotic bee can inject a suitable volume of liquid pollen solution into the recipient flower to enable cross pollination.

Unfortunately, such robotic bees may be subject to various threats while performing such agricultural activities. For example, the robotic bee may get stuck from the gum of a plant. Plant gums are adhesive substances that are carbohydrates in nature and are usually produced as exudates from the bark of trees or shrubs. In another example, the robotic bee may be punctured or prevented from performing an activity, such as extracting pollen from the anther of a plant or injecting pollen into the stigma of the plant, due to thorns, dense brush, spines, glochids, etc. In a further example, the robotic bee may become trapped inside, such as a pitcher plant, by falling into a pitfall trap (prey-trapping mechanism featuring a deep cavity filled with digestive liquid).

Currently, such robotic bees do not have the means for avoiding or responding to such threats. For example, such robotic bees do not have the means to avoid or respond to the threat of getting stuck inside a flower, such as the threat of getting stuck inside a flower due to an uneven surface structure or landing on a sticky substance inside the flower.

The embodiments of the present disclosure provide a means for enabling robotic bees to avoid or respond to threats by generating an impulse force. In one embodiment, a reinforcement learning model is trained to determine an appropriate amount of impulse force to be used by a robotic bee to avoid or respond to a threat based on the type of plant and the classified level of threat. In one embodiment, upon detecting an unbalanced operation of the robotic bee being performed on a plant, such as due to an uneven surface of the plant or a sticky surface of the plant, the type of plant is determined from image data of the plant, such as from images captured by one or more robotic bees using micro cameras. Furthermore, the level of threat is classified based on images of the operation of the robotic bee, such as from images captured from the robotic bee in question or from other surrounding robotic bees. Based on the type of plant and the classified level of threat, an amount of an impulse force to be generated by the robotic bee is determined using the trained reinforcement learning model. An impulse force, as used herein, is a fast-acting force, which is utilized by the robotic bee to move away from the area (e.g., sticky surface of plant) causing the threat. Such an amount of impulse force is instructed to the robotic bee to be generated, such as via a spring or compressed air. In this manner, the robotic bee is able to avoid or respond to a threat by dynamically generating an impulse force. A further discussion regarding these and other features is provided below.

In some embodiments of the present disclosure, the present disclosure comprises a computer-implemented method, system, and computer program product for self-protecting a robotic bee. In one embodiment of the present disclosure, a threat (e.g., landing on a sticky substance on a surface of the plant) in preventing the robotic bee from completing its requested operation (e.g., pollinating a plant) is detected. That is, an unbalanced operation of the robotic bee, such as being performed on the plant, that is caused by a threat is detected. An “unbalanced operation,” as used herein, refers to movements and actions of the robotic bee causing the robotic bee to deviate from a normal mobility path. In one embodiment, such an unbalanced operation is detected based on analyzing the captured images of the operation of the robotic bee being performed on the plant. In one embodiment, such images are analyzed using machine learning based image processing techniques. Furthermore, the type of plant involved in the detected unbalanced operation of the robotic bee is determined. In one embodiment, the type of plant is determined using image data of the plant from the images of the area of activity (area where robotic bees are instructed to perform various operations, such as cross pollination.). Additionally, the level of threat to the robotic bee in not being able to complete its requested operation is classified based on the received images of the operation of the robotic bee being performed on the plant. A “level of threat,” as used herein, refers to an indication as to a likelihood of the robotic bee not being able to complete its requested operation due to an external influence (e.g., being stuck on a sticky surface, landing on an uneven surface structure, etc.). In one embodiment, the level of threat is classified as corresponding to a value, such as between 1 and 10, with 10 indicating the highest likelihood of the robotic bee not being able to complete its requested operation due to an external influence and 1 indicating the lowest likelihood of the robotic bee not being able to complete its requested operation due to an external influence. Based on the type of plant and the classified level of threat, an amount of an impulse force to be generated by the robotic bee is determined using a trained reinforcement learning model. An impulse force, as used herein, is a fast-acting force, which is utilized by the robotic bee to move away from the area (e.g., sticky surface of plant) causing the threat. Such an amount of impulse force is instructed to the robotic bee to be generated, such as via a spring or compressed air. In this manner, the robotic bee is able to avoid or respond to a threat (e.g., falling inside a pitfall trap) in preventing the robotic bee from performing its requested operation or action (e.g., pollinating) by dynamically generating an impulse force.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

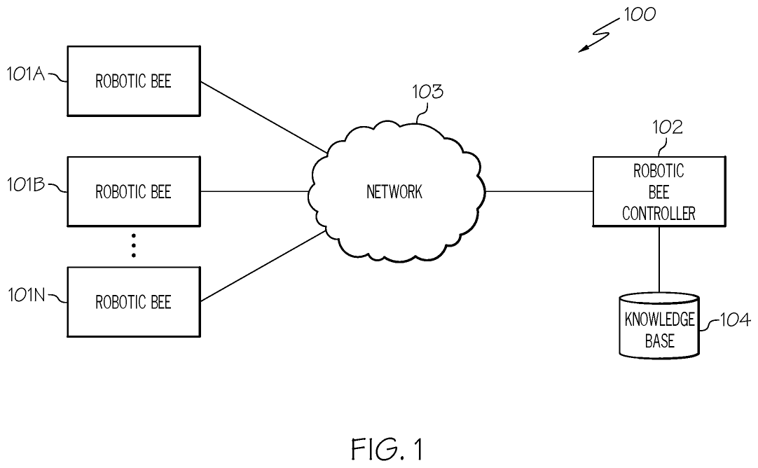

Referring now to the Figures in detail, FIG. 1 illustrates an embodiment of the present disclosure of a communication system 100 for practicing the principles of the present disclosure. Communication system 100 includes robotic bees 101A-101N, where N is a positive integer number, connected to a robotic bee controller 102 via a network 103.

Robotic bees 101A-101N may collectively or individually be referred to as robotic bees 101 or robotic bee 101, respectively. A robotic bee 101, as used herein, refers to a machine designed to do the work of an actual bee, such as pollinating plants as well as monitoring the health of bee hives. In one embodiment, robotic bees 101 are designed to automate the liquid-mediated pollen delivery process. For example, robotic bee 101 may be equipped with an image recognition system to detect suitable recipient flowers for cross pollination. Furthermore, in one embodiment, robotic bee 101 may be equipped to carry a cartridge loaded with liquid pollen solution. Once a suitable recipient flower is identified, robotic bee 101 can inject a suitable volume of liquid pollen solution into the recipient flower to enable cross pollination. Examples of robotic bee 101 can include, but are not limited to, BeeBot, Robee of BloomX, etc.

In one embodiment, robotic bees 101 are equipped with one or more cameras, such as micro cameras used for capturing images of the surrounding area, such as an area of activity where robotic bees 101 are instructed to perform various operations, such as cross pollination. In one embodiment, such micro cameras correspond to first-person view cameras, including charge coupling device (CCD)-type cameras or complementary metal oxide semiconductor (CMOS)-type cameras. For example, in one embodiment, robotic bee 101 implements two mini first-person view (FPV) cameras with the following specifications: Turnigy® Micro FPV, 600 television lines, 768×494 resolution, 30 frames per second (fps), and a 2.1 mm diameter lens with a 150° viewing angle.

In one embodiment, in addition to capturing images of the surrounding area, such as an area of activity where robotic bees 101 are instructed to perform various operations, such robotic bees 101 capture images of the operations being performed by robotic bees 101, such as the operations being performed on a plant in the area of activity. A plant, as used herein, refers to eukaryotes, predominantly photosynthetic, that form the kingdom plantae. In one embodiment, such images of the operations being performed by robotic bee 101 are captured by said robotic bee 101 or are captured by other robotic bees 101 in the area.

Upon capturing such images, such as the images of the area of activity or the images of the operation of a robotic bee 101 being performed on a plant, such images are transmitted to robotic bee controller 102, such as via network 103.

Furthermore, in one embodiment, robotic bee 101 is configured to generate an impulse response to avoid or respond to a threat (e.g., being stuck on a sticky substance on the surface of the plant) in preventing robotic bee 101 from accomplishing its requested operation (e.g., pollinating a plant) based on an instruction received from robotic bee controller 102, which includes the amount of impulse force to be generated. An “impulse force,” as used herein, is a fast-acting force, which is utilized by robotic bee 101 to move away from the area (e.g., sticky surface of plant) causing the threat. In one embodiment, the impulse force is generated via a spring, in which a compressed spring is uncompressed over a designated period of time (e.g., 1 second) so as to cause robotic bee 101 to be propelled over a distance (e.g., 10 mm), such as out of the danger area.

In one embodiment, the impulse is generated via compressed air. In one embodiment, the compressed air is stored in a chamber. In one embodiment, the impulse force is generated by releasing the compressed air over a designated period of time (e.g., 1 second) so as to cause robotic bee 101 to be propelled over a distance (e.g., 10 mm), such as out of the danger area.

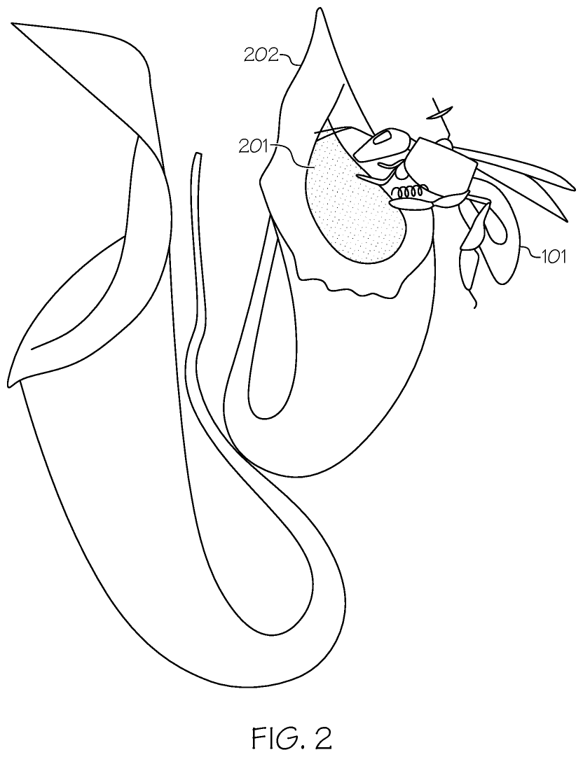

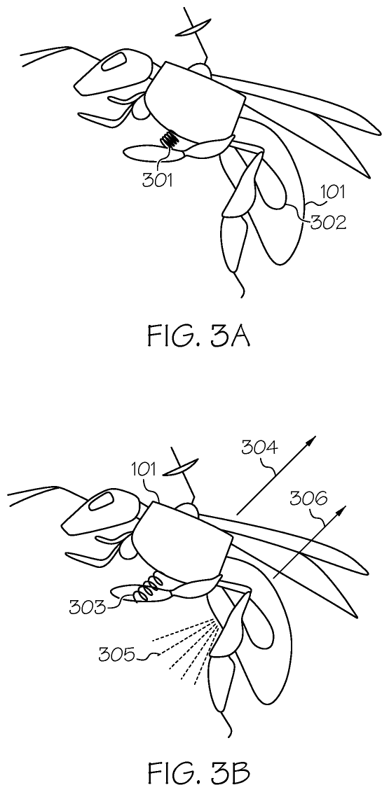

An illustration of robotic bee 101 generating an impulse force, such as via a spring or compressed air, to avoid or respond to a threat (e.g., being stuck on a sticky substance on the surface of the plant) in preventing robotic bee 101 from accomplishing its requested operation (e.g., pollinating a plant) is provided in FIGS. 2 and 3A-3B.

Referring to FIG. 2, FIG. 2 illustrates robotic bee controller 102 and/or robotic bee 101 detecting a threat in preventing robotic bee 101 from accomplishing its requested operation (e.g., pollination of the plant) in accordance with an embodiment of the present disclosure.

As shown in FIG. 2, robotic bee controller 102 and/or robotic bee 101 detects a pitfall trap 201 (prey-trapping mechanism featuring a deep cavity filled with digestive liquid) preventing robotic bee 101 from accomplishing its requested operation (e.g., pollination of the plant) when robotic bee 101 attempts to pollinate plant 202.

In response to such a detection, robotic bee controller 102 instructs robotic bee 101 to generate an impulse force to avoid or respond to the detected threat (e.g., pitfall trap 201) by moving away from the area (e.g., pitfall trap 201) causing the threat as illustrated in FIGS. 3A-3B.

FIGS. 3A-3B illustrate robotic bee 101 generating an impulse force to avoid or respond to the detected threat in accordance with an embodiment of the present disclosure.

As shown in FIG. 3A, robotic bee 101 may include a compressed spring 301 and/or a compressed air chamber 302. In one embodiment, upon the detection of a threat preventing robotic bee 101 from accomplishing its requested operation (e.g., pollination of the plant), robotic bee controller 102 instructs robotic bee 101 to generate a determined amount of impulse force to avoid the detected threat.

Referring to FIG. 3B, in one embodiment, the determined amount of impulse force is generated via a spring (spring force 303), in which a compressed spring is uncompressed over a designated period of time (e.g., 1 second) so as to cause robotic bee 101 to be propelled 304 over a distance (e.g., 10 mm), such as out of the danger area.

In one embodiment, the determined amount of impulse force is generated via the release of compressed air (compressed air jet 305), in which the compressed air is released over a designated period of time (e.g., 1 second) so as to cause robotic bee 101 to be propelled 306 over a distance (e.g., 10 mm), such as out of the danger area.

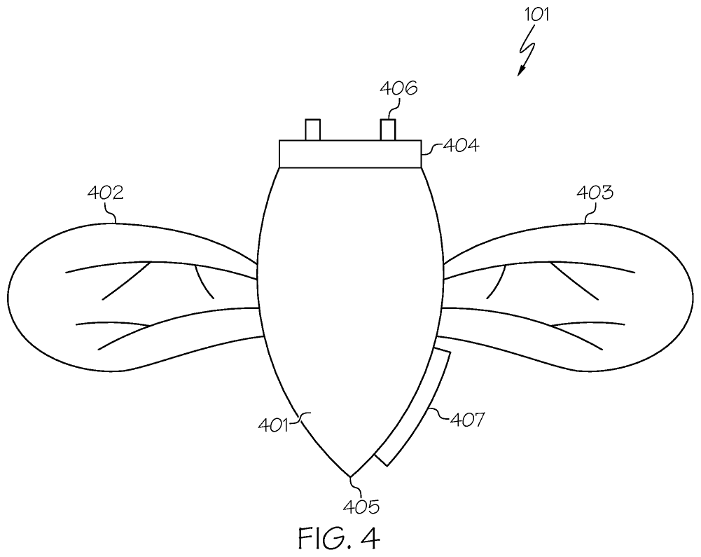

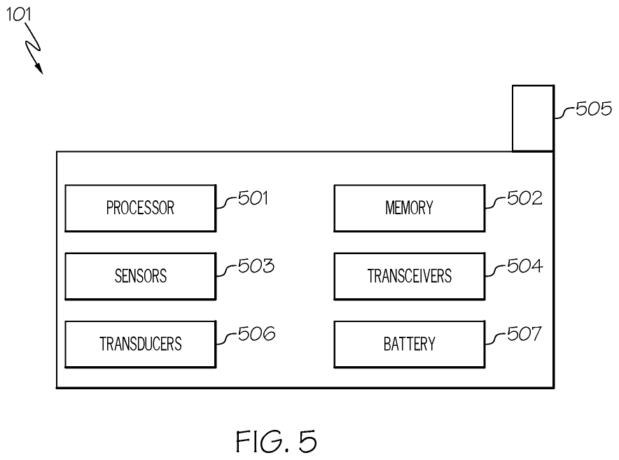

A further discussion regarding an external view of robotic bee 101 and the internal components of robotic bee 101 is discussed below in connection with FIGS. 4 and 5, respectively.

Returning to FIG. 1, in one embodiment, robotic bee controller 102 is configured to issue commands and actions to robotic bees 101, such as instructing robotic bees 101 to perform certain actions (e.g., injecting pollen into the stigma of a designated plant, generating a designated amount of impulse force to avoid or respond to a threat) at certain locations within the area of activity. Other examples of issued commands and actions from robotic bee controller 102 include establishing the navigation path of robotic bee 101.

In one embodiment, robotic bee controller 102 is configured to receive the images captured by robotic bees 101 to generate a map of the area of activity, including the relative positions of robotic bees 101 in the area.

Furthermore, in one embodiment, robotic bee controller 102 is configured to detect an unbalanced operation of robotic bee 101 being performed on a plant that is caused by a threat. An “unbalanced operation,” as used herein, refers to movements and actions of robotic bee 101 causing robotic bee 101 to deviate from a normal mobility path. For example, such an unbalanced operation may cause robotic bee 101 to be unsteady so that robotic bee 101 is likely to tip or fall, such as due to hitting a thorn, and therefore, modifies the normal mobility path thereby preventing robotic bee 101 from performing the requested operation or action. In another example, such an unbalanced operation is caused by robotic bee 101 being stuck on a sticky surface of the plant thereby modifying the normal mobility path and preventing robotic bee 101 from performing the requested operation or action. A normal mobility path, as used herein, refers to a standard, typical, or expected path of movement to perform the requested operation. In one embodiment, such normal mobility paths for performing various operations from various directions starting from various originations are stored in knowledge base 104 (discussed further below) connected to robotic bee controller 102. In one embodiment, such knowledge base 104 is populated by an expert.

In one embodiment, such an unbalanced operation is detected based on analyzing the captured images of the operation of robotic bee 101 being performed on a plant. Such images may then be analyzed using machine learning based image processing techniques. In one embodiment, a machine learning model is trained to predict unbalanced operations based on images of operations of robotic bees 101. Based on inputting such captured images of the operations of robotic bee 101 to the trained model, the trained model predicts whether an unbalanced operation has been detected.

In one embodiment, robotic bee controller 102 is configured to determine the type of plant involved in the detected unbalanced operation of robotic bee 101 using image data of the plant from the images of the area of activity. In one embodiment, the type of plant is determined based on analyzing such images using machine learning based image processing techniques. In one embodiment, a machine learning model is trained to predict the type of plant based on images of the plant. Based on inputting such captured images of the plant to the trained model, the trained model predicts the type of plant.

In one embodiment, robotic bee controller 102 is configured to classify the level of threat to robotic bee 101 based on the received images of the operation being performed on a plant by robotic bee 101. A “level of threat,” as used herein, refers to an indication as to a likelihood of robotic bee 101 being unable to complete its requested operation due to an external influence (e.g., being stuck on a sticky surface, landing on an uneven surface structure, etc.). In one embodiment, the level of threat is classified as corresponding to a value, such as between 1 and 10, with 10 indicating the highest likelihood of robotic bee 101 not being able to complete its requested operation due to an external influence and 1 indicating the lowest likelihood of robotic bee 101 not being able to complete its requested operation due to an external influence. In one embodiment, the classification of the level of threat to robotic bee 101 is based on analyzing the received images of the operation being performed on a plant by robotic bee 101 using machine learning based image processing techniques. In one embodiment, a machine learning model is trained to classify the level of threat to robotic bee 101 not being able to complete its requested operation due to an eternal influence based on images of the operation being performed on a plant by robotic bee 101. Based on inputting such captured images of the operation being performed on a plant by robotic bee 101 to the trained model, the trained model classifies the level of threat to robotic bee 101 being unable to complete its requested operation due to an external influence (e.g., being stuck on a sticky surface, landing on an uneven surface structure, etc.).

Additionally, in one embodiment, robotic bee controller 102 is configured to determine the amount of impulse force to be generated by robotic bee 101 to avoid or respond to a threat, such as landing on a sticky substance on a surface of the plant, in preventing robotic bee 101 from completing its requested operation (e.g., pollinating a plant). As discussed above, an “impulse force,” as used herein, is a fast-acting force, which is utilized by robotic bee 101 to move away from the area (e.g., sticky surface of plant) causing the threat. In one embodiment, the amount of impact force is determined using a trained reinforcement learning model based on the type of plant and the classified level of threat.

In one embodiment, robotic bee controller 102 trains such a model using an initial guess for the required impulse force based on a classified level of threat and a type of plant using a knowledge base 104 connected to robotic bee controller 102. Knowledge base 104, as used herein, refers to a repository of information concerning the required impulse force to be generated by robotic bee 101 based on the type of plant and the classified level of threat. In one embodiment, knowledge base 104 is populated by an expert. In another embodiment, knowledge base 104 is populated based on prior amounts of impulse force that successfully caused robotic bee 101 to avoid or respond to a threat without damaging the plant based on the type of plant and the classified level of threat.

In one embodiment, upon providing the initial guess for the required impulse force to the reinforcement learning model, robotic bee controller 102 trains the model on a reward and punishment mechanism. For example, a reinforcement learning agent is rewarded for correct moves and punished for wrong moves. In one embodiment, the reinforcement learning agent is rewarded based on a rate of change of the mobility path to the correct mobility path and punished for damage to a plant.

A mobility path, as used herein, refers to the path of movement to perform the requested operation. The rate of change of a mobility path, as used herein, refers to the rate of changing the mobility path. As previously discussed, an unbalanced operation refers to movements and actions of robotic bee 101 that deviate from a normal mobility path or the “correct” mobility. Such a normal or correct mobility path refers to a standard, typical, or expected path of movement to perform the requested operation, which may be stored in knowledge base 104. In one embodiment, the higher the rate of change of the mobility path to the correct mobility path, the greater the reward and vice-versa.

Damage to a plant, as used herein, refers to harm caused to the plant, including breakage and abrasions to the plant and soil disturbances. In one embodiment, damage to a plant is assessed by robotic bee controller 102 based on analyzing the images of the area of activity captured by robotic bees 101, which include images of the plant in question. Such images may then be analyzed using machine learning based image processing techniques. In one embodiment, a machine learning model is trained to predict the extent of the damage to the plant based on the images of the plant in question. Based on inputting such captured images of the plant to the trained model, the trained model predicts whether damage has been suffered by the plant, and if so, the extent of such damage. In one embodiment, the greater the damage of the plant, the greater the punishment and vice-versa.

In one embodiment, robotic bee controller 102 is configured to instruct robotic bee 101 to generate the determined amount of impulse force to avoid or respond to a threat of robotic bee 101 not being able to complete its requested operation.

A further discussion regarding these and other features is provided below.

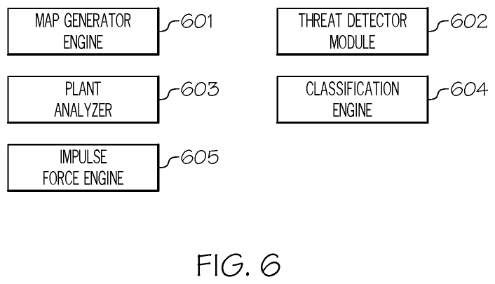

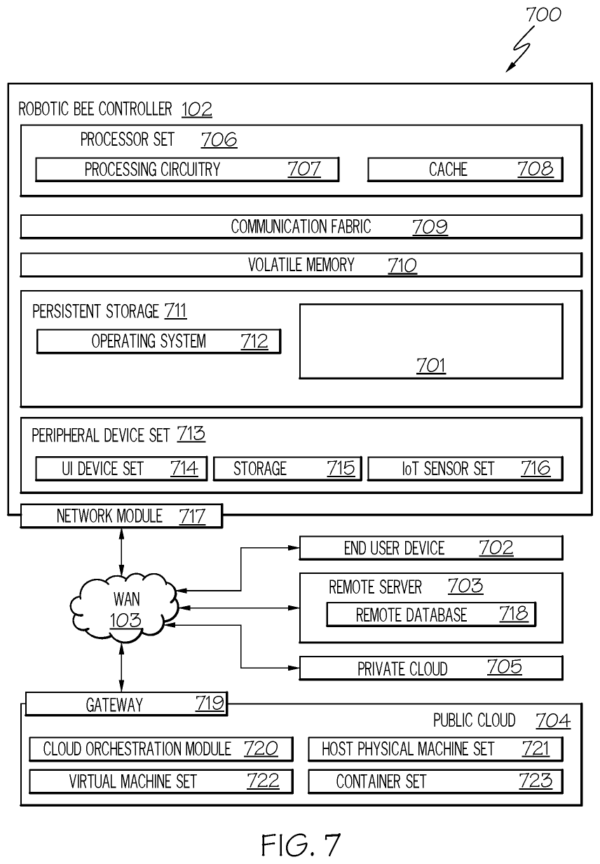

A description of the software components of robotic bee controller 102 used for protecting robotic bee 101 from threats by dynamically generating an impulse force is provided below in connection with FIG. 6. A description of the hardware configuration of robotic bee controller 102 is provided further below in connection with FIG. 7.

As discussed above, robotic bees 101 are connected to robotic bee controller 102 via a network 103. Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of robotic bees 101, robot bee controllers 102, networks 103, and knowledge bases 104.

A discussion regarding the external view of robotic bee 101 is provided below in connection with FIG. 4.

FIG. 4 illustrates an external view of robotic bee 101 in accordance with an embodiment of the present disclosure.

Referring to FIG. 4, in conjunction with FIG. 1, robotic bee 101 includes a body 401 and two wings 402, 403. In one embodiment, body 401 includes a head 404 and a pointed tail 405. To facilitate flying, body 401 is hollow and the body casing is made of light material. In one embodiment, the body casing is made of polycarbonate. The two wings 402, 403 are attached to either side of body 401. As illustrated in FIG. 4, robotic bee 101 is substantially similar to a real bee in shape and size.

In one embodiment, the exemplary robotic bee 101 shown in FIG. 4 has a body 401 of dimensions 2.5 cm×2.0 cm×1.5 cm. In one embodiment, the size of body 401 is substantially the same as one of the two wings 402, 403. In one embodiment, each wing 402, 403 is approximately 2 cm long and the total wing span is 6 cm. It is noted that such sizes are for illustration purposes and should not be interpreted as limiting. The exemplary robotic bee 101 can be made into other suitable body sizes, body components, and proportions.

In one embodiment, body 401 is hollow and can accommodate various electrical and mechanical components, such as processors, transducers, signal receivers and transmitters, etc. As discussed above, body 401 includes head 404 and tail 405. In one embodiment, head 404 includes one or more cameras 406. Cameras 406 may be binocular or monocular. In one embodiment, cameras 406 are located on the front or top of head 404. In another embodiment, cameras 406 are located on the underside of head 404, facing downward to allow cameras 406 to capture images of the field beneath robotic bee 101.

In one embodiment, at least one of the cameras 406 is a normal camera suitable for use during the day. In another embodiment, at least one of the cameras 406 is a night vision camera suitable for use at night. When robotic bee 101 is equipped with a normal and a night vision camera, robotic bee 101 can work day and night, allowing it to work more hours in a day if needed to meet a deadline or to avoid bad weather, for example. In one embodiment, robotic bee 101 is equipped with other types of cameras or video recorders. The images or videos taken by the cameras may be stored in memory devices carried by robotic bee 101 and sent to a processor of robotic bee 101 for image processing or sent to robotic bee controller 102 for image processing. Pattern recognition software may be used to analyze the images taken by cameras 406 in order to identify a specific type of plant (e.g., flower), such as being designated as a pollination target.

As discussed above, in one embodiment, cameras 406 are used for capturing images of the surrounding area, such as an area of activity where robotic bees 101 are instructed to perform various operations, such as cross pollination. In one embodiment, cameras 406 are micro cameras corresponding to first-person view cameras, including charge coupling device (CCD)-type cameras or complementary metal oxide semiconductor (CMOS)-type cameras. For example, in one embodiment, cameras 406 correspond to two mini first-person view (FPV) cameras with the following specifications: Turnigy® Micro FPV, 600 television lines, 768×494 resolution, 30 frames per second (fps), and a 2.1 mm diameter lens with a 150° viewing angle.

Furthermore, in one embodiment, body 401 is elongated and resembles the body of a real bee. However, in some embodiments, body 401 may be shaped differently. For example, the contour of body 401 may be shaped angularly at one or more locations. In one embodiment, the upper side of body 401 may be smooth but the underside of body 401 may be angular, for example, rectangularly shaped. In one embodiment, the underside of body 401 is covered by a piece of coarse fabric 407, used as a cover to collect pollen when in contact with the anther of a plant.

In one embodiment, when it is time to release collected pollen onto a stigma, robotic bee 101 approaches the stigma. Bits or sacs of the pollen affixed to the fabric are knocked off when coarse fabric 407 comes into contact with the stigma. It is noted that the process of collecting and releasing pollen by coarse fabric 407 emulates the pollinating process of a bee. When a bee stops on an anther, the tiny hairs on the bee's legs pick up pollen from the anther. Tiny pollen particles cling to the bee hairs, the same way they cling to a piece of coarse fabric 407. In one embodiment, the pollen particles do not fall off during flight, but when robotic bee 101 lands on the next plant, a few pollen particles will be dislodged and fall onto a stigma.

In one embodiment, robotic bee 101 is equipped with a variety of sensors to aid navigation and flight. For example, cameras 406 may be installed to capture images or videos for pattern recognition and image processing. Wind sensors can be installed on the surface of body 401 to measure the strength and direction of the wind. Readings from a wind sensor can be used for flight control (e.g., selecting a more energy efficient route) or for navigation (e.g., selecting a flight direction that takes into account the blow of the wind). Other sensors can be installed on the surface of body 401 to measure temperature, humidity, and/or pressure. In some embodiments, robotic bee 101 is equipped with a distance sensor to measure the distance to a pollination target. The reading from a distance sensor can inform robotic bee 101 that it is approaching a pollination target. In such a case, robotic bee 101 may be configured to slow down or turn around to align itself with the target. In some embodiments, robotic bee 101 may carry a GPS reader, the readings of which provide location information of robotic bee 101. In one embodiment, robotic bee 101 transmits its location information to robotic bee controller 102 for tracking purposes. Alternatively, robotic bee 101 can carry a tracking device to allow robotic bee controller 102 to track its location as it flies around.

In one embodiment, robotic bee 101 is constructed with two wings 402, 403 that are made of light and durable materials. In one embodiment, wings 402, 403 are made with carbon fiber that meets the requirements of requisite density and strength. In some embodiments, wings 402, 403 include a frame with one or more ribs as support. In one embodiment, wings 402, 403 are covered by a piece of skin. In one embodiment, the dimensions of wings 402, 403 are substantially similar to those of a real bee. In one embodiment, the length of wing 402, 403 is approximately 2 cm. In one embodiment, the shape of wing 402, 403 may resemble that of a real bee as shown in FIG. 4. In some embodiments, the shape of wing 402, 403 may be different from that of a real bee, to accommodate various design considerations, such as manufacturing costs, material limitations, etc.

In one embodiment, robotic bee 101 carries a battery as the power source. MEMS devices may be used to convert the electric energy of the battery into mechanical movements. Because the size of robotic bee 101 is small and the energy it consumes is also small, energy harvesting can be effectively used as a supplemental power source in addition to the battery carried onboard by robotic bee 101. In some embodiments, solar panels are installed on the surface of robotic bee 101. The solar energy harvested by the solar panels is converted into electric energy/chemical energy stored in the battery. In some embodiments, piezoelectric materials may be installed to convert vibrational energy of robotic bee 101 into electric energy. Well known piezoelectric materials include quartz, synthetic crystals, synthetic ceramics, polymers, and nanostructures. Piezoelectric materials generate electric potential when experiencing mechanical stress. For example, the electric dipoles inside a typical piezoelectric material become aligned when pressure is applied on the material, inducing a voltage between two spots on the surface of the material. When connected to a battery, the induced voltage can re-charge the battery, converting mechanic energy into electricity.

In one embodiment, powered by the battery carried onboard, robotic bee 101 is autonomous. It can be self-directed and self-driven. Cameras 406 act as the “eyes” of robotic bee 101 and the various sensors act as the “antennas.”

Referring now to FIG. 5, FIG. 5 illustrates the internal components of robotic bee 101 in accordance with an embodiment of the present disclosure.

As illustrated in FIG. 5, robotic bee 101 includes a processor 501 and a memory 502 for the various computation tasks described herein. Processor 501 and memory 502 are configured to process and store data generated by the various sensors 503. Examples of sensors 503 installed on robotic bee 101 include cameras (e.g., cameras 406), wind sensors, temperature/pressure/humidity sensors, GPS readers, etc. The readings from sensors 503 are stored in memory 502 and processed by processor 501. In some embodiments, robotic bee 101 communicates with robotic bee controller 102 via a network 103 and may be configured to transmit the sensor data to robotic bee controller 102 for further processing. For that purpose, robotic bee 101 is equipped with wireless transceivers 504 (combination of a transmitter/receiver in a single package). In one embodiment, transceivers 504 are configured to transmit and receive wireless data through an antenna 505 installed on robotic bee 101. In some embodiments, robotic bee 101 is configured to autonomously control its flight operation with little or no interaction with robotic bee controller 102. In some embodiments, robotic bee 101 is configured with limited computing power and relies on robotic bee controller 102 for directions and commands. Processor 501 either interprets the commands robotic bee 101 receives from robotic bee controller 102 or generates commands in-situ after processing and computing the sensor data. Using the commands, processor 501 controls the movements of robotic bee 101 via transducers 506.

In one embodiment, wings 402, 403 (FIG. 4) of robotic bee 101 are connected to two transducers 506, respectively. In one embodiment, processor 501 controls transducers 506 separately and wings 402, 403 can move independently of each other. In other embodiments, wings 402, 403 may be configured to move synchronously. In yet another embodiment, robotic bee 101 is equipped with a propeller (not shown) configured to provide lift power. The propeller may be configured to work without or in aid of wings 402, 403.

Furthermore, in one embodiment, robotic bee 101 includes a battery 507, which provides power to the electronic components. In one embodiment, robotic bee 101 is connected to a power source via an electric wire. In some embodiments, battery 507 provides power to the mechanical parts of robotic bee 101 allowing robotic bee 101 to move freely without being tied to a ground power source. In some embodiments, robotic bee 101 may be powered or charged via wireless power transmission.

A discussion regarding the software components used by robotic bee controller 102 to protect robotic bee 101 from threats by dynamically generating an impulse force is provided below in connection with FIG. 6.

FIG. 6 is a diagram of the software components used by robotic bee controller 102 to protect robotic bee 101 from threats by dynamically generating an impulse force in accordance with an embodiment of the present disclosure.

Referring to FIG. 6, in conjunction with FIGS. 1-2, 3A-3B and 4-5, robotic bee controller 102 includes a map generator engine 601 configured to generate a map of an area, such as the area of activity, including the relative positions of robotic bees 101 in the area based on images of the area of activity received from robotic bees 101.

In one embodiment, robotic bee controller 102 receives images of an area of activity from robotic bees 101, including images of plants and robotic bees 101 in the area of activity. An area of activity, as used herein, refers to the area where robotic bees 101 are instructed to perform various operations, such as cross pollination.

As discussed above, in one embodiment, robotic bees 101 are equipped with one or more cameras 406, such as micro cameras used for capturing images of the surrounding area, such as an area of activity where robotic bees 101 are instructed to perform various operations, such as cross pollination. Such images are then transmitted to robotic bee controller 102 via network 103. In one embodiment, such cameras 406 correspond to first-person view cameras, including charge coupling device (CCD)-type cameras or complementary metal oxide semiconductor (CMOS)-type cameras. For example, in one embodiment, cameras 406 correspond to two mini first-person view (FPV) cameras with the following specifications: Turnigy® Micro FPV, 600 television lines, 768×494 resolution, 30 frames per second (fps), and a 2.1 mm diameter lens with a 150° viewing angle.

Upon receiving the images of the area of activity where robotic bees 101 are instructed to perform various operations, such as cross pollination, map generator engine 601 generates a map of the area, including the relative positions of robotic bees 101 in the area, based on the images of the area of activity received from robotic bees 101. In one embodiment, such images received from robotic bees 101 include data (or tagged with data) pertaining to the location where they were taken using the GPS reader of robotic bee 101. Such geolocation data may then be used to generate a map of the objects (e.g., plants, robotic bees 101) in the area of activity upon which such images were taken. Map generator engine 601 utilizes various software tools for generating such a map of the area of activity, which can include, but are not limited to, iMap®, GeoSetter, ExifTool, GeoPhoto®, GPicSync, etc.

In one embodiment, the generated map defines a set of job locations for robotic bees 101. In one embodiment, the generated map also associates one or more job operations with one or more of the job locations in the set of job locations. In one embodiment, each job location in the generated map corresponds to an actual location in the physical environment. Some of the job locations will also have associated with them a set of one or more job operations to be carried out automatically by robotic bee 101 after robotic bee 101 arrives at the actual location.

In one embodiment, robotic bee controller 102 includes a threat detector module 602 configured to determine if robotic bee 101 has detected a threat from performing the requested operation or action. That is, threat detector module 602 determines whether an unbalanced operation of robotic bee 101 being performed on a plant that was caused by a threat has been detected. An “unbalanced operation,” as used herein, refers to movements and actions of robotic bee 101 causing robotic bee 101 to deviate from a normal mobility path. For example, such an unbalanced operation may cause robotic bee 101 to be unsteady so that robotic bee 101 is likely to tip or fall, such as due to hitting a thorn, and therefore, modifies the normal mobility path thereby preventing robotic bee 101 from performing the requested operation or action. In another example, such an unbalanced operation is caused by robotic bee 101 being stuck on a sticky surface of the plant thereby modifying the normal mobility path and preventing robotic bee 101 from performing the requested operation or action. A normal mobility path, as used herein, refers to a standard, typical, or expected path of movement to perform the requested operation. In one embodiment, such normal mobility paths for performing various operations from various directions starting from various originations are stored in knowledge base 104. In one embodiment, such knowledge base 104 is populated by an expert.

In one embodiment, such an unbalanced operation is detected by threat detector module 602 based on analyzing the captured images of the operation of robotic bee 101 being performed on a plant. In one embodiment, such images are a portion of the images received from robotic bees 101 pertaining to the area of activity.

In one embodiment, threat detector module 602 analyzes such images using machine learning based image processing techniques. In one embodiment, threat detector module 602 trains a machine learning model to predict unbalanced operations based on images of operations of robotic bees 101. Based on inputting such captured images of the operations of robotic bee 101 to the trained model, the trained model predicts whether an unbalanced operation has been detected.

In one embodiment, threat detector module 602 builds and trains a model to predict unbalanced operations based on images of operations of robotic bees 101.

In one embodiment, the model is trained to predict or determine unbalanced operations of robotic bees 101 based on a sample data set that includes captured images of the operations of robotic bees 101. Such a sample data set may be stored in a data structure (e.g., table) residing within the storage device of robotic bee controller 102. In one embodiment, such a data structure is populated by an expert.

Furthermore, in one embodiment, the sample data set discussed above is referred to herein as the “training data,” which is used by a machine learning algorithm to make predictions or decisions as to the detection of an unbalanced operation of robotic bee 101 being performed on a plant. The algorithm iteratively makes predictions on the training data as to the detection of an unbalanced operation of robotic bee 101 being performed on a plant until the predictions achieve the desired accuracy as determined by an expert. Examples of such learning algorithms include nearest neighbor, Naïve Bayes, decision trees, linear regression, support vector machines, and neural networks.

Additionally, robotic bee controller 102 includes a plant analyzer 603 configured to determine the type of plant involved in the detected unbalanced operation of robotic bee 101. That is, plant analyzer 603 is configured to determine the type of plant (e.g., Helianthus annuus) that robotic bee 101 was instructed to perform its operation (e.g., pollination) on.

In one embodiment, plant analyzer 603 is configured to determine the type of plant using image data of the plant from the images of the area of activity. In one embodiment, the type of plant is determined based on analyzing such images using machine learning based image processing techniques. In one embodiment, a machine learning model is trained to predict the type of plant based on images of the plant. Based on inputting such captured images of the plant to the trained model, the trained model predicts the type of plant.

In one embodiment, plant analyzer 603 builds and trains a model to predict the type of plant involved in the detected unbalanced operation of robotic bee 101.

In one embodiment, the model is trained to predict the type of plant involved in the detected unbalanced operation of robotic bee 101 based on a sample data set that includes captured images of plants. Such a sample data set may be stored in a data structure (e.g., table) residing within the storage device of robotic bee controller 102. In one embodiment, such a data structure is populated by an expert.

Furthermore, in one embodiment, the sample data set discussed above is referred to herein as the “training data,” which is used by a machine learning algorithm to make predictions or decisions as to the type of plant, such as the type of plant involved in the detected unbalanced operation of robotic bee 101. The algorithm iteratively makes predictions on the training data as to the determination of the type of plant until the predictions achieve the desired accuracy as determined by an expert. Examples of such learning algorithms include nearest neighbor, Naïve Bayes, decision trees, linear regression, support vector machines, and neural networks.

Furthermore, robotic bee controller 102 includes a classification engine 604 configured to classify the level of threat to robotic bee 101 not being able to complete its requested operation based on the received images of the operation of robotic bee 101 being performed on the plant.

In one embodiment, the images of the operation of robotic bee 101 being performed on the plant are obtained by robotic bee controller 102 either directly from robotic bee 101 in question or from the surrounding robotic bees 101 as they capture images of the area of activity.

In one embodiment, a “level of threat,” as used herein, refers to an indication as to a likelihood of robotic bee 101 being unable to complete its requested operation due to an external influence (e.g., being stuck on a sticky surface, landing on an uneven surface structure, etc.). In one embodiment, the level of threat is classified as corresponding to a value, such as between 1 and 10, with 10 indicating the highest likelihood of robotic bee 101 not being able to complete its requested operation due to an external influence and 1 indicating the lowest likelihood of robotic bee 101 not being able to complete its requested operation due to an external influence. In one embodiment, the classification of the level of threat to robotic bee 101 is based on analyzing the received images of the operation being performed on a plant by robotic bee 101 using machine learning based image processing techniques. In one embodiment, a machine learning model is trained to classify the level of threat to robotic bee 101 not being able to complete its requested operation due to an eternal influence based on images of the operation being performed on a plant by robotic bee 101. Based on inputting such captured images of the operation being performed on a plant by robotic bee 101 to the trained model, the trained model classifies the level of threat to robotic bee 101 being unable to complete its requested operation due to an external influence (e.g., being stuck on a sticky surface, landing on an uneven surface structure, etc.).

In one embodiment, classification engine 604 builds and trains a model to classify the level of threat to robotic bee 101 not being able to complete its requested operation based on the received images of the operation of robotic bee 101 being performed on the plant.

In one embodiment, the model is trained to classify the level of threat to robotic bee 101 not being able to complete its requested operation based on a sample data set that includes captured images of the operation being performed on the plant by robotic bee 101. Such a sample data set may be stored in a data structure (e.g., table) residing within the storage device of robotic bee controller 102. In one embodiment, such a data structure is populated by an expert.

Furthermore, in one embodiment, the sample data set discussed above is referred to herein as the “training data,” which is used by a machine learning algorithm to make predictions or decisions as to the classification of the level of threat to robotic bee 101 not being able to complete its requested operation. The algorithm iteratively makes predictions on the training data as to the determination of the classification of the level of threat to robotic bee 101 not being able to complete its requested operation until the predictions achieve the desired accuracy as determined by an expert. Examples of such learning algorithms include nearest neighbor, Naïve Bayes, decision trees, linear regression, support vector machines, and neural networks.

Furthermore, robotic bee controller 102 includes an impulse force engine 605 configured to determine the amount of impulse force to be generated by robotic bee 101, such as via spring force 303 or compressed air jet 305, to avoid or respond to a threat, such as landing on a sticky substance on a surface of the plant, in preventing robotic bee 101 from completing its requested operation (e.g., pollinating a plant). As discussed above, an “impulse force,” as used herein, is a fast-acting force, which is utilized by robotic bee 101 to move away from the area (e.g., sticky surface of plant) causing the threat. In one embodiment, the amount of impact force is determined using a trained reinforcement learning model based on the type of plant and the classified level of threat.

In one embodiment, impulse force engine 605 trains such a model using an initial guess for the required impulse force based on a classified level of threat and a type of plant using knowledge base 104. As discussed above, knowledge base 104, as used herein, refers to a repository of information concerning the required impulse force to be generated by robotic bee 101 based on the type of plant and the classified level of threat. In one embodiment, knowledge base 104 is populated by an expert. In another embodiment, knowledge base 104 is populated based on prior amounts of impulse force that successfully caused robotic bee 101 to avoid or respond to a threat without damaging the plant based on the type of plant and the classified level of threat.

In one embodiment, upon providing the initial guess for the required impulse force to the reinforcement learning model, impulse force engine 605 trains the model on a reward and punishment mechanism. For example, a reinforcement learning agent is rewarded for correct moves and punished for wrong moves. In one embodiment, the reinforcement learning agent is rewarded based on a rate of change of the mobility path to the correct mobility path and punished for damage to a plant.

A mobility path, as used herein, refers to the path of movement to perform the requested operation. The rate of change of a mobility path, as used herein, refers to the rate of changing the mobility path. As previously discussed, an unbalanced operation refers to movements and actions of robotic bee 101 that deviate from a normal mobility path or the “correct” mobility. Such a normal or correct mobility path refers to a standard, typical, or expected path of movement to perform the requested operation, which may be stored in knowledge base 104. In one embodiment, the higher the rate of change of the mobility path to the correct mobility path, the greater the reward and vice-versa.

Damage to a plant, as used herein, refers to harm caused to the plant, including breakage and abrasions to the plant and soil disturbances. In one embodiment, damage to a plant is assessed by impulse force engine 605 based on analyzing the images of the area of activity captured by robotic bees 101, which include images of the plant in question. Such images may then be analyzed using machine learning based image processing techniques. In one embodiment, a machine learning model is trained to predict the extent of the damage to the plant based on the images of the plant in question. Based on inputting such captured images of the plant to the trained model, the trained model predicts whether damage has been suffered by the plant, and if so, the extent of such damage. In one embodiment, the greater the damage of the plant, the greater the punishment and vice-versa.

In one embodiment, impulse force engine 605 builds and trains a model to predict the damage to the plant caused by robotic bee 101 generating the impulse force to avoid or respond to the threat.

In one embodiment, the model is trained to predict the damage to the plant caused by robotic bee 101 generating the impulse force to avoid or respond to the threat based on a sample data set that includes images of the area of activity captured by robotic bees 101, which include images of the plant in question. Such a sample data set may be stored in a data structure (e.g., table) residing within the storage device of robotic bee controller 102. In one embodiment, such a data structure is populated by an expert.

Furthermore, in one embodiment, the sample data set discussed above is referred to herein as the “training data,” which is used by a machine learning algorithm to make predictions or decisions as to the damage to the plant caused by robotic bee 101 generating the impulse force to avoid or respond to the threat. The algorithm iteratively makes predictions on the training data as to the damage to the plant caused by robotic bee 101 generating the impulse force to avoid or respond to the threat until the predictions achieve the desired accuracy as determined by an expert. Examples of such learning algorithms include nearest neighbor, Naïve Bayes, decision trees, linear regression, support vector machines, and neural networks.

As discussed above, in one embodiment, in order to optimally set the impulse force based on the rate of change of mobility and damage to the plant, damages to the plant are penalized and moving away from the threat (change of the mobility to the correct mobility path) is rewarded. As previously discussed, the initial guess of the impulse force to be used to train the reinforcement learning model is acquired from knowledge base 104 based on the type of plant and the classified level of threat.

In one embodiment, the training of the reinforcement learning model to determine the amount of impulse force to be generated by robotic bee 101 to avoid or respond to a threat, such as landing on a sticky substance on a surface of the plant, in preventing robotic bee 101 from completing its requested operation (e.g., pollinating a plant) is represented mathematically as shown below.

$${Q}^{new} ( {s}_{t} , {a}_{t} ) ← \underbrace{Q ( {s}_{t} , {a}_{t} )}_{current value} + \underbrace{α}_{learning rate} \cdot \overbrace{( \underbrace{\underbrace{{r}_{t}}_{reward} + \underbrace{γ}_{discount factor} \cdot \underbrace{{max}_{a} Q ( {s}_{t + 1} , a )}_{estimate of optimal future value}}_{new value ( temporal difference target )} - \underbrace{Q ( {s}_{t} , {a}_{t} )}_{current value} )}^{temporal difference}$$

where sₜ represents the state at “t” and aₜ represents the impulse force intensity (action) at “t,” and where Q represents the quality of state Q:S×A→ [symbol] . Furthermore, rₜ is the reward received from moving from state (sₜ) to state (sₜ₊₁), calculated based on the rate of change of unusual mobility trajectory (penalize for a higher rate of change and entering the vulnerable zone (area where the threat to prevent robotic bee 101 from accomplishing its requested operation is located)). Q(sₜ,aₜ) is the current quality of state and actions combination max( [symbol] (sₜ₊₁,aₜ)), the maximum reward that can be obtained from state sₜ₊₁. γ (the discount factor) is a number between 0 and 1 (0≤γ≤1) and has the effect of valuing rewards received earlier higher than those received later (reflecting the value of a “good start”).

In one embodiment, impulse force engine 605 trains the reinforcement learning model to determine an amount of impulse force based on the above-identified mathematical representation using various software tools, including OpenAI® Gym to implement a reinforcement learning agent to be rewarded for correct moves and to be punished for wrong moves. In one embodiment, the reinforcement learning agent is rewarded based on a rate of change of the mobility path to the correct mobility path and punished for damage to a plant. Other software tools used by impulse force engine 605 to train the reinforcement learning model to determine an amount of impulse force based on the above-identified mathematical representation can include, but are not limited to, TensorFlow® TF-Agents, ReAgent by Meta®, OpenSpiel, Amazon SageMaker® RL, etc.

Furthermore, in one embodiment, upon determining the amount of impulse force to be generated by robotic bee 101, such as via spring force 303 or compressed air jet 305, to avoid or respond to a threat in preventing robotic bee 101 from completing its requested operation, impulse force engine 605 instructs robotic bee 101 to generate such a determined amount of impulse force to avoid or respond to the threat in preventing robotic bee 101 from completing its requested operation.

For example, based on such an instruction, robotic bee 101 generates the determined amount of impulse force via a spring (spring force 303), in which a compressed spring is uncompressed over a designated period of time (e.g., 1 second) so as to cause robotic bee 101 to be propelled 304 over a distance (e.g., 10 mm), such as out of the danger area, as illustrated in FIG. 3B. Furthermore, in another example, based on such an instruction, robotic bee 101 generates the determined amount of impulse force via the release of compressed air (compressed air jet 305), in which the compressed air is released over a designated period of time (e.g., 1 second) so as to cause robotic bee 101 to be propelled 306 over a distance (e.g., 10 mm), such as out of the danger area, as illustrated in FIG. 3B.

A further description of these and other features is provided below in connection with the discussion of the method for protecting robotic bees from threats in preventing them from completing their requested operations by dynamically generating an impulse force.

Prior to the discussion of the method for protecting robotic bees from threats in preventing them from completing their requested operations by dynamically generating an impulse force, a description of the hardware configuration of robotic bee controller 102 (FIG. 1) is provided below in connection with FIG. 7.

Referring now to FIG. 7, in conjunction with FIG. 1, FIG. 7 illustrates an embodiment of the present disclosure of the hardware configuration of robot bee controller 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code (computer code for protecting robotic bees from threats in preventing them from completing their requested operations by dynamically generating an impulse force, which is stored in block 701) involved in performing the disclosed methods, such as protecting robotic bees from threats in preventing them from completing their requested operations by dynamically generating an impulse force. In addition to block 701, computing environment 700 includes, for example, robotic bee controller 102, network 103, such as a wide area network (WAN), end user device (EUD) 702, remote server 703, public cloud 704, and private cloud 705. In this embodiment, robotic bee controller 102 includes processor set 706 (including processing circuitry 707 and cache 708), communication fabric 709, volatile memory 710, persistent storage 711 (including operating system 712 and block 701, as identified above), peripheral device set 713 (including user interface (UI) device set 714, storage 715, and Internet of Things (IoT) sensor set 716), and network module 717. Remote server 703 includes remote database 718. Public cloud 704 includes gateway 719, cloud orchestration module 720, host physical machine set 721, virtual machine set 722, and container set 723.

Robotic bee controller 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 718. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically robotic bee controller 102, to keep the presentation as simple as possible. Robotic bee controller 102 may be located in a cloud, even though it is not shown in a cloud in FIG. 7. On the other hand, robotic bee controller 102 is not required to be in a cloud except to any extent as may be affirmatively indicated.

Processor set 706 includes one, or more, computer processors of any type now known or to be developed in the future. Processing circuitry 707 may be distributed over multiple packages, for example, multiple, coordinated integrated circuit chips. Processing circuitry 707 may implement multiple processor threads and/or multiple processor cores. Cache 708 is memory that is located in the processor chip package(s) and is typically used for data or code that should be available for rapid access by the threads or cores running on processor set 706. Cache memories are typically organized into multiple levels depending upon relative proximity to the processing circuitry. Alternatively, some, or all, of the cache for the processor set may be located “off chip.” In some computing environments, processor set 706 may be designed for working with qubits and performing quantum computing.

Computer readable program instructions are typically loaded onto robotic bee controller 102 to cause a series of operational steps to be performed by processor set 706 of robotic bee controller 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 708 and the other storage media discussed below. The program instructions, and associated data, are accessed by processor set 706 to control and direct performance of the disclosed methods. In computing environment 700, at least some of the instructions for performing the disclosed methods may be stored in block 701 in persistent storage 711.

Communication fabric 709 is the signal conduction paths that allow the various components of robotic bee controller 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 710 is any type of volatile memory now known or to be developed in the future. Examples include dynamic type random access memory (RAM) or static type RAM. Typically, the volatile memory is characterized by random access, but this is not required unless affirmatively indicated. In robotic bee controller 102, the volatile memory 710 is located in a single package and is internal to robotic bee controller 102, but, alternatively or additionally, the volatile memory may be distributed over multiple packages and/or located externally with respect to robotic bee controller 102.

Persistent Storage 711 is any form of non-volatile storage for computers that is now known or to be developed in the future. The non-volatility of this storage means that the stored data is maintained regardless of whether power is being supplied to robotic bee controller 102 and/or directly to persistent storage 711. Persistent storage 711 may be a read only memory (ROM), but typically at least a portion of the persistent storage allows writing of data, deletion of data and re-writing of data. Some familiar forms of persistent storage include magnetic disks and solid state storage devices. Operating system 712 may take several forms, such as various known proprietary operating systems or open source Portable Operating System Interface type operating systems that employ a kernel. The code included in block 701 typically includes at least some of the computer code involved in performing the disclosed methods.

Peripheral device set 713 includes the set of peripheral devices of robotic bee controller 102. Data communication connections between the peripheral devices and the other components of robotic bee controller 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 714 may include components such as a display screen, speaker, microphone, wearable devices (such as goggles and smart watches), keyboard, mouse, printer, touchpad, game controllers, and haptic devices. Storage 715 is external storage, such as an external hard drive, or insertable storage, such as an SD card. Storage 715 may be persistent and/or volatile. In some embodiments, storage 715 may take the form of a quantum computing storage device for storing data in the form of qubits. In embodiments where robotic bee controller 102 is required to have a large amount of storage (for example, where robotic bee controller 102 locally stores and manages a large database) then this storage may be provided by peripheral storage devices designed for storing very large amounts of data, such as a storage area network (SAN) that is shared by multiple, geographically distributed computers. IoT sensor set 716 is made up of sensors that can be used in Internet of Things applications. For example, one sensor may be a thermometer and another sensor may be a motion detector.

Network module 717 is the collection of computer software, hardware, and firmware that allows robotic bee controller 102 to communicate with other computers through WAN 103. Network module 717 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 717 are performed on the same physical hardware device. In other embodiments (for example, embodiments that utilize software-defined networking (SDN)), the control functions and the forwarding functions of network module 717 are performed on physically separate devices, such that the control functions manage several different network hardware devices. Computer readable program instructions for performing the disclosed methods can typically be downloaded to robotic bee controller 102 from an external computer or external storage device through a network adapter card or network interface included in network module 717.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 702 is any computer system that is used and controlled by an end user (for example, a customer of an enterprise that operates robotic bee controller 102), and may take any of the forms discussed above in connection with robotic bee controller 102. EUD 702 typically receives helpful and useful data from the operations of robotic bee controller 102. For example, in a hypothetical case where robotic bee controller 102 is designed to provide a recommendation to an end user, this recommendation would typically be communicated from network module 717 of robotic bee controller 102 through WAN 103 to EUD 702. In this way, EUD 702 can display, or otherwise present, the recommendation to an end user. In some embodiments, EUD 702 may be a client device, such as thin client, heavy client, mainframe computer, desktop computer and so on.

Remote server 703 is any computer system that serves at least some data and/or functionality to robotic bee controller 102. Remote server 703 may be controlled and used by the same entity that operates robotic bee controller 102. Remote server 703 represents the machine(s) that collect and store helpful and useful data for use by other computers, such as robotic bee controller 102. For example, in a hypothetical case where robotic bee controller 102 is designed and programmed to provide a recommendation based on historical data, then this historical data may be provided to robotic bee controller 102 from remote database 718 of remote server 703.

Public cloud 704 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 704 is performed by the computer hardware and/or software of cloud orchestration module 720.

The computing resources provided by public cloud 704 are typically implemented by virtual computing environments that run on various computers making up the computers of host physical machine set 721, which is the universe of physical computers in and/or available to public cloud 704. The virtual computing environments (VCEs) typically take the form of virtual machines from virtual machine set 722 and/or containers from container set 723. It is understood that these VCEs may be stored as images and may be transferred among and between the various physical machine hosts, either as images or after instantiation of the VCE. Cloud orchestration module 720 manages the transfer and storage of images, deploys new instantiations of VCEs and manages active instantiations of VCE deployments. Gateway 719 is the collection of computer software, hardware, and firmware that allows public cloud 704 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 705 is similar to public cloud 704, except that the computing resources are only available for use by a single enterprise. While private cloud 705 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 704 and private cloud 705 are both part of a larger hybrid cloud.

Block 701 further includes the software components discussed above in connection with FIG. 6 to protect robotic bees from threats in preventing them from completing their requested operations by dynamically generating an impulse force. In one embodiment, such components may be implemented in hardware. The functions discussed above performed by such components are not generic computer functions. As a result, robotic bee controller 102 is a particular machine that is the result of implementing specific, non-generic computer functions.

In one embodiment, the functionality of such software components of robotic bee controller 102, including the functionality for protecting robotic bees from threats in preventing them from completing their requested operations by dynamically generating an impulse force, may be embodied in an application specific integrated circuit.

As stated above, a robotic bee is designed to automate the liquid-mediated pollen delivery process. For example, a robotic bee may be equipped with an image recognition system to detect suitable recipient flowers for cross pollination. A robotic bee may also be equipped to carry a cartridge loaded with liquid pollen solution. Once a suitable recipient flower is identified, the robotic bee can inject a suitable volume of liquid pollen solution into the recipient flower to enable cross pollination. Unfortunately, such robotic bees may be subject to various threats while performing such agricultural activities. For example, the robotic bee may get stuck from the gum of a plant. Plant gums are adhesive substances that are carbohydrates in nature and are usually produced as exudates from the bark of trees or shrubs. In another example, the robotic bee may be punctured or prevented from performing an activity, such as extracting pollen from the anther of a plant or injecting pollen into the stigma of the plant, due to thorns, dense brush, spines, glochids, etc. In a further example, the robotic bee may become trapped inside, such as a pitcher plant, by falling into a pitfall trap (prey-trapping mechanism featuring a deep cavity filled with digestive liquid). Currently, such robotic bees do not have the means for avoiding or responding to such threats. For example, such robotic bees do not have the means to avoid or respond to the threat of getting stuck inside a flower, such as the threat of getting stuck inside a flower due to an uneven surface structure or landing on a sticky substance inside the flower.

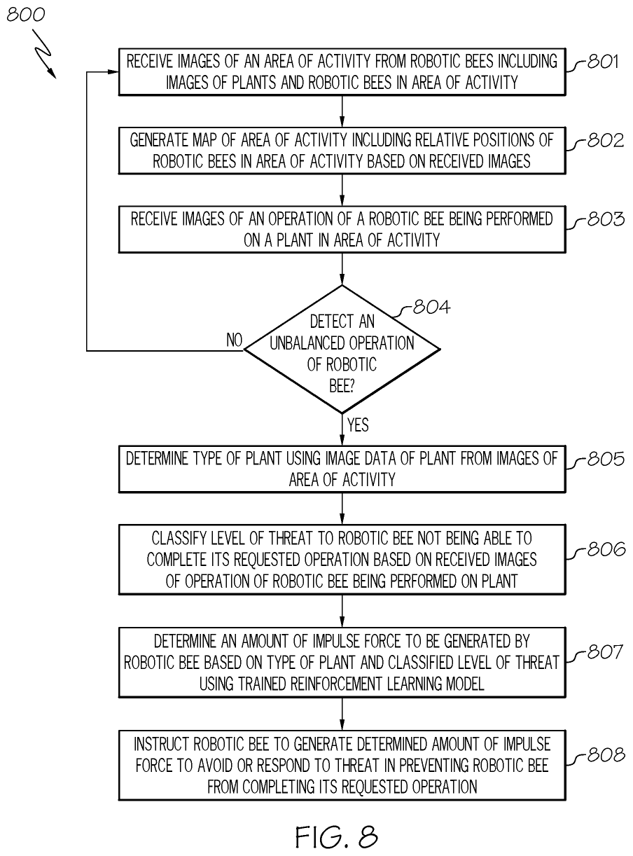

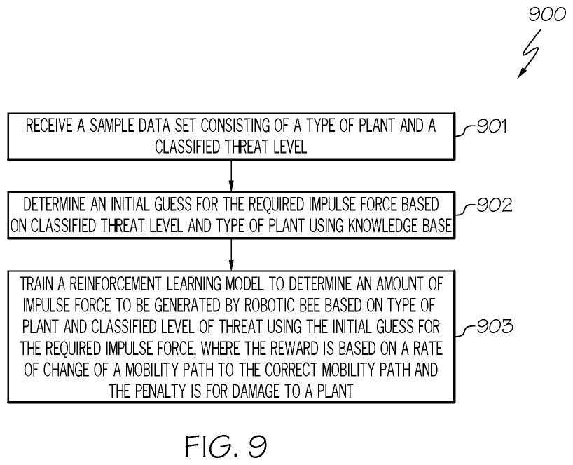

The embodiments of the present disclosure provide a means for enabling robotic bees to avoid or respond to threats in preventing them from completing their requested operations by generating an impulse force as discussed below in connection with FIGS. 8 and 9. FIG. 8 is a flowchart of a method for protecting robotic bees from threats in preventing them from completing their requested operations by dynamically generating an impulse force. FIG. 9 is a flowchart of a method for training a reinforcement learning model for determining an amount of impulse force to be generated by the robotic bee to avoid or respond to the threat in preventing the robotic bee from completing its requested operation.

As discussed above, FIG. 8 is a flowchart of a method 800 for protecting robotic bees from threats in preventing them from completing their requested operations by dynamically generating an impulse force in accordance with an embodiment of the present disclosure.

Referring to FIG. 8, in conjunction with FIGS. 1-2, 3A-3B and 4-7, in operation 801, robotic bee controller 102 receives images of an area of activity from robotic bees 101, including images of plants and robotic bees 101 in the area of activity.

As discussed above, an area of activity, as used herein, refers to the area where robotic bees 101 are instructed to perform various operations, such as cross pollination.

As further discussed above, in one embodiment, robotic bees 101 are equipped with one or more cameras 406, such as micro cameras used for capturing images of the surrounding area, such as an area of activity where robotic bees 101 are instructed to perform various operations, such as cross pollination. Such images are then transmitted to robotic bee controller 102 via network 103. In one embodiment, such cameras 406 correspond to first-person view cameras, including charge coupling device (CCD)-type cameras or complementary metal oxide semiconductor (CMOS)-type cameras. For example, in one embodiment, cameras 406 correspond to two mini first-person view (FPV) cameras with the following specifications: Turnigy® Micro FPV, 600 television lines, 768×494 resolution, 30 frames per second (fps), and a 2.1 mm diameter lens with a 150° viewing angle.

In operation 802, map generator engine 601 of robotic bee controller 102 generates a map of an area, such as the area of activity, including the relative positions of robotic bees 101 in the area based on the images of the area of activity received from robotic bees 101.

As stated above, in one embodiment, such images received from robotic bees 101 include data (or tagged with data) pertaining to the location where they were taken using the GPS reader of robotic bee 101. Such geolocation data may then be used to generate a map of the objects (e.g., plants, robotic bees 101) in the area of activity upon which such images were taken. Map generator engine 601 utilizes various software tools for generating such a map of the area of activity, which can include, but are not limited to, iMap®, GeoSetter, ExifTool, GeoPhoto®, GPicSync, etc.

In one embodiment, the generated map defines a set of job locations for robotic bees 101. In one embodiment, the generated map also associates one or more job operations with one or more of the job locations in the set of job locations. In one embodiment, each job location in the generated map corresponds to an actual location in the physical environment. Some of the job locations will also have associated with them a set of one or more job operations to be carried out automatically by robotic bee 101 after robotic bee 101 arrives at the actual location.

In operation 803, robotic bee controller 102 receives images of an operation of robotic bee 101 being performed on a plant in the area of activity. In one embodiment, such images are a portion of the images received from robotic bees 101 pertaining to the area of activity.

In operation 804, threat detector module 602 of robotic bee controller 102 determines if a threat (e.g., landing on a sticky substance on a surface of the plant) in preventing robotic bee 101 from completing its requested operation (e.g., pollinating a plant) has been detected. That is, threat detector module 602 determines whether an unbalanced operation of robotic bee 101 being performed on a plant that was caused by a threat has been detected.

As discussed above, an “unbalanced operation,” as used herein, refers to movements and actions of robotic bee 101 causing robotic bee 101 to deviate from a normal mobility path. For example, such an unbalanced operation may cause robotic bee 101 to be unsteady so that robotic bee 101 is likely to tip or fall, such as due to hitting a thorn, and therefore, modifies the normal mobility path thereby preventing robotic bee 101 from performing the requested operation or action. In another example, such an unbalanced operation is caused by robotic bee 101 being stuck on a sticky surface of the plant thereby modifying the normal mobility path and preventing robotic bee 101 from performing the requested operation or action. A normal mobility path, as used herein, refers to a standard, typical, or expected path of movement to perform the requested operation. In one embodiment, such normal mobility paths for performing various operations from various directions starting from various originations are stored in knowledge base 104. In one embodiment, such knowledge base 104 is populated by an expert.

In one embodiment, such an unbalanced operation is detected by threat detector module 602 based on analyzing the captured images of the operation of robotic bee 101 being performed on a plant. In one embodiment, such images are a portion of the images received from robotic bees 101 pertaining to the area of activity.

In one embodiment, threat detector module 602 analyzes such images using machine learning based image processing techniques. In one embodiment, threat detector module 602 trains a machine learning model to predict unbalanced operations based on images of operations of robotic bees 101. Based on inputting such captured images of the operations of robotic bee 101 to the trained model, the trained model predicts whether an unbalanced operation has been detected.

In one embodiment, threat detector module 602 builds and trains a model to predict unbalanced operations based on images of operations of robotic bees 101.

In one embodiment, the model is trained to predict or determine unbalanced operations of robotic bees 101 based on a sample data set that includes captured images of the operations of robotic bees 101. Such a sample data set may be stored in a data structure (e.g., table) residing within the storage device (e.g., storage device 711, 715) of robotic bee controller 102. In one embodiment, such a data structure is populated by an expert.

Furthermore, in one embodiment, the sample data set discussed above is referred to herein as the “training data,” which is used by a machine learning algorithm to make predictions or decisions as to the detection of an unbalanced operation of robotic bee 101 being performed on a plant. The algorithm iteratively makes predictions on the training data as to the detection of an unbalanced operation of robotic bee 101 being performed on a plant until the predictions achieve the desired accuracy as determined by an expert. Examples of such learning algorithms include nearest neighbor, Naïve Bayes, decision trees, linear regression, support vector machines, and neural networks.

If threat detector module 602 does not detect an unbalanced operation of robotic bee 101 being performed on the plant, then robotic bee controller 102 continues to receive images of an area of activity from robotic bees 101 in operation 801.

If, however, threat detector module 602 detects an unbalanced operation of robotic bee 101 being performed on the plant, then, in operation 805, plant analyzer 603 of robotic bee controller 102 determines the type of plant involved in the detected unbalanced operation of robotic bee 101. That is, plant analyzer 603 is configured to determine the type of plant (e.g., Helianthus annuus) that robotic bee 101 was instructed to perform its operation (e.g., pollination) on.

As stated above, in one embodiment, plant analyzer 603 is configured to determine the type of plant using image data of the plant from the images of the area of activity. In one embodiment, the type of plant is determined based on analyzing such images using machine learning based image processing techniques. In one embodiment, a machine learning model is trained to predict the type of plant based on images of the plant. Based on inputting such captured images of the plant to the trained model, the trained model predicts the type of plant.

In one embodiment, plant analyzer 603 builds and trains a model to predict the type of plant involved in the detected unbalanced operation of robotic bee 101.

In one embodiment, the model is trained to predict the type of plant involved in the detected unbalanced operation of robotic bee 101 based on a sample data set that includes captured images of plants. Such a sample data set may be stored in a data structure (e.g., table) residing within the storage device (e.g., storage device 711, 715) of robotic bee controller 102. In one embodiment, such a data structure is populated by an expert.

Furthermore, in one embodiment, the sample data set discussed above is referred to herein as the “training data,” which is used by a machine learning algorithm to make predictions or decisions as to the type of plant, such as the type of plant involved in the detected unbalanced operation of robotic bee 101. The algorithm iteratively makes predictions on the training data as to the determination of the type of plant until the predictions achieve the desired accuracy as determined by an expert. Examples of such learning algorithms include nearest neighbor, Naïve Bayes, decision trees, linear regression, support vector machines, and neural networks.

In operation 806, classification engine 604 of robotic bee controller 102 classifies the level of threat to robotic bee 101 not being able to complete its requested operation based on the received images of the operation of robotic bee 101 being performed on the plant.

As discussed above, in one embodiment, the images of the operation of robotic bee 101 being performed on the plant are obtained by robotic bee controller 102 either directly from robotic bee 101 in question or from the surrounding robotic bees 101 as they capture images of the area of activity.

In one embodiment, a “level of threat,” as used herein, refers to an indication as to a likelihood of robotic bee 101 being unable to complete its requested operation due to an external influence (e.g., being stuck on a sticky surface, landing on an uneven surface structure, etc.). In one embodiment, the level of threat is classified as corresponding to a value, such as between 1 and 10, with 10 indicating the highest likelihood of robotic bee 101 not being able to complete its requested operation due to an external influence and 1 indicating the lowest likelihood of robotic bee 101 not being able to complete its requested operation due to an external influence. In one embodiment, the classification of the level of threat to robotic bee 101 is based on analyzing the received images of the operation being performed on a plant by robotic bee 101 using machine learning based image processing techniques. In one embodiment, a machine learning model is trained to classify the level of threat to robotic bee 101 not being able to complete its requested operation due to an eternal influence based on images of the operation being performed on a plant by robotic bee 101. Based on inputting such captured images of the operation being performed on a plant by robotic bee 101 to the trained model, the trained model classifies the level of threat to robotic bee 101 being unable to complete its requested operation due to an external influence (e.g., being stuck on a sticky surface, landing on an uneven surface structure, etc.).

In one embodiment, classification engine 604 builds and trains a model to classify the level of threat to robotic bee 101 not being able to complete its requested operation based on the received images of the operation of robotic bee 101 being performed on the plant.

In one embodiment, the model is trained to classify the level of threat to robotic bee 101 not being able to complete its requested operation based on a sample data set that includes captured images of the operation being performed on the plant by robotic bee 101. Such a sample data set may be stored in a data structure (e.g., table) residing within the storage device (e.g., storage device 711, 715) of robotic bee controller 102. In one embodiment, such a data structure is populated by an expert.

Furthermore, in one embodiment, the sample data set discussed above is referred to herein as the “training data,” which is used by a machine learning algorithm to make predictions or decisions as to the classification of the level of threat to robotic bee 101 not being able to complete its requested operation. The algorithm iteratively makes predictions on the training data as to the determination of the classification of the level of threat to robotic bee 101 not being able to complete its requested operation until the predictions achieve the desired accuracy as determined by an expert. Examples of such learning algorithms include nearest neighbor, Naïve Bayes, decision trees, linear regression, support vector machines, and neural networks.

In operation 807, impulse force engine 605 of robotic bee controller 102 determines the amount of impulse force to be generated by robotic bee 101, such as via spring force 303 or compressed air jet 305, to avoid or respond to a threat, such as landing on a sticky substance on a surface of the plant, in preventing robotic bee 101 from completing its requested operation (e.g., pollinating a plant). As discussed above, an “impulse force,” as used herein, is a fast-acting force, which is utilized by robotic bee 101 to move away from the area (e.g., sticky surface of plant) causing the threat. In one embodiment, the amount of impact force is determined using a trained reinforcement learning model based on the type of plant (see operation 805) and the classified level of threat (see operation 806) as discussed below in connection with FIG. 9.

FIG. 9 is a flowchart of a method 900 for training a reinforcement learning model for determining an amount of impulse force to be generated by the robotic bee to avoid or respond to the threat in preventing the robotic bee from completing its requested operation in accordance with an embodiment of the present disclosure.

Referring to FIG. 9, in conjunction with FIGS. 1-2, 3A-3B and 4-8, in operation 901, impulse force engine 605 of robotic bee controller 102 receives a sample data set consisting of a type of plant and a classified threat level.

In operation 902, impulse force engine 605 of robotic bee controller 102 determines an initial guess for the required impulse force based on the classified threat level and the type of plant (received in operation 901) using knowledge base 104.

As discussed above, in one embodiment, impulse force engine 605 trains a reinforcement learning model for determining an amount of impulse force to be generated by robotic bee 101 to avoid or respond to the threat in preventing robotic bee 101 from completing its requested operation using an initial guess for the required impulse force based on a classified level of threat and a type of plant using knowledge base 104. As also discussed above, knowledge base 104, as used herein, refers to a repository of information concerning the required impulse force to be generated by robotic bee 101 based on the type of plant and the classified level of threat. In one embodiment, knowledge base 104 is populated by an expert. In another embodiment, knowledge base 104 is populated based on prior amounts of impulse force that successfully caused robotic bee 101 to avoid or respond to a threat without damaging the plant based on the type of plant and the classified level of threat.

Upon providing the initial guess for the required impulse force to the reinforcement learning model, in operation 903, impulse force engine 605 of robotic bee controller 102 trains the model to determine the amount of impulse force to be generated by robotic bee 101 based on the type of plant and classified level of threat using the initial guess for the required impulse force on a reward and punishment mechanism. For example, a reinforcement learning agent is rewarded for correct moves and punished for wrong moves. In one embodiment, the reinforcement learning agent is rewarded based on a rate of change of the mobility path to the correct mobility path and punished for damage to a plant.

As discussed above, a mobility path, as used herein, refers to the path of movement to perform the requested operation. The rate of change of a mobility path, as used herein, refers to the rate of changing the mobility path. As previously discussed, an unbalanced operation refers to movements and actions of robotic bee 101 that deviate from a normal mobility path or the “correct” mobility. Such a normal or correct mobility path refers to a standard, typical, or expected path of movement to perform the requested operation, which may be stored in knowledge base 104. In one embodiment, the higher the rate of change of the mobility path to the correct mobility path, the greater the reward and vice-versa.

Damage to a plant, as used herein, refers to harm caused to the plant, including breakage and abrasions to the plant and soil disturbances. In one embodiment, damage to a plant is assessed by impulse force engine 605 based on analyzing the images of the area of activity captured by robotic bees 101, which include images of the plant in question. Such images may then be analyzed using machine learning based image processing techniques. In one embodiment, a machine learning model is trained to predict the extent of the damage to the plant based on the images of the plant in question. Based on inputting such captured images of the plant to the trained model, the trained model predicts whether damage has been suffered by the plant, and if so, the extent of such damage. In one embodiment, the greater the damage of the plant, the greater the punishment and vice-versa.

In one embodiment, impulse force engine 605 builds and trains a model to predict the damage to the plant caused by robotic bee 101 generating the impulse force to avoid or respond to the threat.

In one embodiment, the model is trained to predict the damage to the plant caused by robotic bee 101 generating the impulse force to avoid or respond to the threat based on a sample data set that includes images of the area of activity captured by robotic bees 101, which include images of the plant in question. Such a sample data set may be stored in a data structure (e.g., table) residing within the storage device (e.g., storage device 711, 715) of robotic bee controller 102. In one embodiment, such a data structure is populated by an expert.

Furthermore, in one embodiment, the sample data set discussed above is referred to herein as the “training data,” which is used by a machine learning algorithm to make predictions or decisions as to the damage to the plant caused by robotic bee 101 generating the impulse force to avoid or respond to the threat. The algorithm iteratively makes predictions on the training data as to the damage to the plant caused by robotic bee 101 generating the impulse force to avoid or respond to the threat until the predictions achieve the desired accuracy as determined by an expert. Examples of such learning algorithms include nearest neighbor, Naïve Bayes, decision trees, linear regression, support vector machines, and neural networks.

As discussed above, in one embodiment, in order to optimally set the impulse force based on the rate of change of mobility and damage to the plant, damages to the plant are penalized and moving away from the threat (change of the mobility to the correct mobility path) is rewarded. As previously discussed, the initial guess of the impulse force to be used to train the reinforcement learning model is acquired from knowledge base 104 based on the type of plant and the classified level of threat.

In one embodiment, the training of the reinforcement learning model to determine the amount of impulse force to be generated by robotic bee 101 to avoid or respond to a threat, such as landing on a sticky substance on a surface of the plant, in preventing robotic bee 101 from completing its requested operation (e.g., pollinating a plant) is represented mathematically as shown below.

$${Q}^{new} ( {s}_{t} , {a}_{t} ) ← \underbrace{Q ( {s}_{t} , {a}_{t} )}_{current value} + \underbrace{α}_{learning rate} \cdot \overbrace{( \underbrace{\underbrace{{r}_{t}}_{reward} + \underbrace{γ}_{discount factor} \cdot \underbrace{{max}_{a} Q ( {s}_{t + 1} , a )}_{estimate of optimal future value}}_{new value ( temporal difference target )} - \underbrace{Q ( {s}_{t} , {a}_{t} )}_{current value} )}^{temporal difference}$$

where sₜ represents the state at “t” and at represents the impulse force intensity (action) at “t,” and where Q represents the quality of state Q:S×A→ [symbol] . Furthermore, rₜ is the reward received from moving from state (sₜ) to state (sₜ₊₁), calculated based on the rate of change of unusual mobility trajectory (penalize for a higher rate of change and entering the vulnerable zone (area where the threat to prevent robotic bee 101 from accomplishing its requested operation is located)). Q(sₜ,aₜ) is the current quality of state and actions combination max( [symbol] (sₜ₊₁,aₜ)), the maximum reward that can be obtained from state sₜ₊₁. γ (the discount factor) is a number between 0 and 1 (0≤γ≤1) and has the effect of valuing rewards received earlier higher than those received later (reflecting the value of a “good start”).

In one embodiment, impulse force engine 605 trains the reinforcement learning model to determine an amount of impulse force based on the above-identified mathematical representation using various software tools, including OpenAI® Gym to implement a reinforcement learning agent to be rewarded for correct moves and to be punished for wrong moves. In one embodiment, the reinforcement learning agent is rewarded based on a rate of change of the mobility path to the correct mobility path and punished for damage to a plant. Other software tools used by impulse force engine 605 to train the reinforcement learning model to determine an amount of impulse force based on the above-identified mathematical representation can include, but are not limited to, TensorFlow® TF-Agents, ReAgent by Meta®, OpenSpiel, Amazon SageMaker® RL, etc.

Returning to FIG. 8, in conjunction with FIGS. 1-2, 3A-3B, 4-7 and 9, upon determining the amount of impulse force to be generated by robotic bee 101, such as via spring force 303 or compressed air jet 305, to avoid or respond to a threat in preventing robotic bee 101 from completing its requested operation, in operation 808, impulse force engine 605 of robotic bee controller 102 instructs robotic bee 101 to generate such a determined amount of impulse force to avoid or respond to the threat in preventing robotic bee 101 from completing its requested operation.

For example, based on such an instruction, robotic bee 101 generates the determined amount of impulse force via a spring (spring force 303), in which a compressed spring is uncompressed over a designated period of time (e.g., 1 second) so as to cause robotic bee 101 to be propelled 304 over a distance (e.g., 10 mm), such as out of the danger area, as illustrated in FIG. 3B. Furthermore, in another example, based on such an instruction, robotic bee 101 generates the determined amount of impulse force via the release of compressed air (compressed air jet 305), in which the compressed air is released over a designated period of time (e.g., 1 second) so as to cause robotic bee 101 to be propelled 306 over a distance (e.g., 10 mm), such as out of the danger area, as illustrated in FIG. 3B.

In this manner, robotic bees are able to avoid or respond to a threat (e.g., falling inside a pitfall trap) in preventing the robotic bees from performing their requested operation or action (e.g., pollinating) by dynamically generating an impulse force.

Furthermore, the principles of the present disclosure improve the technology or technical field involving robotic bees.

As discussed above, a robotic bee is designed to automate the liquid-mediated pollen delivery process. For example, a robotic bee may be equipped with an image recognition system to detect suitable recipient flowers for cross pollination. A robotic bee may also be equipped to carry a cartridge loaded with liquid pollen solution. Once a suitable recipient flower is identified, the robotic bee can inject a suitable volume of liquid pollen solution into the recipient flower to enable cross pollination. Unfortunately, such robotic bees may be subject to various threats while performing such agricultural activities. For example, the robotic bee may get stuck from the gum of a plant. Plant gums are adhesive substances that are carbohydrates in nature and are usually produced as exudates from the bark of trees or shrubs. In another example, the robotic bee may be punctured or prevented from performing an activity, such as extracting pollen from the anther of a plant or injecting pollen into the stigma of the plant, due to thorns, dense brush, spines, glochids, etc. In a further example, the robotic bee may become trapped inside, such as a pitcher plant, by falling into a pitfall trap (prey-trapping mechanism featuring a deep cavity filled with digestive liquid). Currently, such robotic bees do not have the means for avoiding or responding to such threats. For example, such robotic bees do not have the means to avoid or respond to the threat of getting stuck inside a flower, such as the threat of getting stuck inside a flower due to an uneven surface structure or landing on a sticky substance inside the flower.

Embodiments of the present disclosure improve such technology by detecting a threat (e.g., landing on a sticky substance on a surface of the plant) in preventing the robotic bee from completing its requested operation (e.g., pollinating a plant). That is, an unbalanced operation of the robotic bee, such as being performed on the plant, that is caused by a threat is detected. An “unbalanced operation,” as used herein, refers to movements and actions of the robotic bee causing the robotic bee to deviate from a normal mobility path. In one embodiment, such an unbalanced operation is detected based on analyzing the captured images of the operation of the robotic bee being performed on the plant. In one embodiment, such images are analyzed using machine learning based image processing techniques. Furthermore, the type of plant involved in the detected unbalanced operation of the robotic bee is determined. In one embodiment, the type of plant is determined using image data of the plant from the images of the area of activity (area where robotic bees are instructed to perform various operations, such as cross pollination.). Additionally, the level of threat to the robotic bee in not being able to complete its requested operation is classified based on the received images of the operation of the robotic bee being performed on the plant. A “level of threat,” as used herein, refers to an indication as to a likelihood of the robotic bee not being able to complete its requested operation due to an external influence (e.g., being stuck on a sticky surface, landing on an uneven surface structure, etc.). In one embodiment, the level of threat is classified as corresponding to a value, such as between 1 and 10, with 10 indicating the highest likelihood of the robotic bee not being able to complete its requested operation due to an external influence and 1 indicating the lowest likelihood of the robotic bee not being able to complete its requested operation due to an external influence. Based on the type of plant and the classified level of threat, an amount of an impulse force to be generated by the robotic bee is determined using a trained reinforcement learning model. An impulse force, as used herein, is a fast-acting force, which is utilized by the robotic bee to move away from the area (e.g., sticky surface of plant) causing the threat. Such an amount of impulse force is instructed to the robotic bee to be generated, such as via a spring or compressed air. In this manner, the robotic bee is able to avoid or respond to a threat (e.g., falling inside a pitfall trap) in preventing the robotic bee from performing its requested operation or action (e.g., pollinating) by dynamically generating an impulse force. Furthermore, in this manner, there is an improvement in the technical field involving robotic bees.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for self-protecting a robotic bee, the method comprising:
detecting an unbalanced operation of the robotic bee being performed on a plant;
determining a type of the plant using image data of the plant in response to the detected unbalanced operation of the robotic bee;
classifying a level of threat of the robotic bee not being able to complete its requested operation based on received images of the operation of the robotic bee in response to the detected unbalanced operation of the robotic bee; and
instructing the robotic bee to generate an impulse force based on the type of the plant and the classified level of threat.

2. The method as recited in claim 1, wherein the impulse force is generated via a spring.

3. The method as recited in claim 1, wherein the impulse force is generated via compressed air.

4. The method as recited in claim 1, wherein the unbalanced operation of the robotic bee is due to an uneven surface of the plant or a sticky surface of the plant.

5. The method as recited in claim 1 further comprising:
receiving images of an area of activity from a plurality of robotic bees, wherein the area of activity corresponds to an area where the plurality of robotic bees are instructed to perform various operations, wherein the images of the area of activity comprise the image data of the plant.

6. The method as recited in claim 1 further comprising:
training a reinforcement learning model to determine an amount of the impulse force to be generated by the robotic bee based on the type of the plant and the classified level of threat.

7. The method as recited in claim 6, wherein a reward is calculated based on a rate of change of a mobility path to a correct mobility path, wherein a penalty is calculated based on damage to the plant.

8. A computer program product for self-protecting a robotic bee, the computer program product comprising one or more computer readable storage mediums having program code embodied therewith, the program code comprising programming instructions for:
detecting an unbalanced operation of the robotic bee being performed on a plant;
determining a type of the plant using image data of the plant in response to the detected unbalanced operation of the robotic bee;
classifying a level of threat of the robotic bee not being able to complete its requested operation based on received images of the operation of the robotic bee in response to the detected unbalanced operation of the robotic bee; and
instructing the robotic bee to generate an impulse force based on the type of the plant and the classified level of threat.

9. The computer program product as recited in claim 8, wherein the impulse force is generated via a spring.

10. The computer program product as recited in claim 8, wherein the impulse force is generated via compressed air.

11. The computer program product as recited in claim 8, wherein the unbalanced operation of the robotic bee is due to an uneven surface of the plant or a sticky surface of the plant.

12. The computer program product as recited in claim 8, wherein the program code further comprises the programming instructions for:
receiving images of an area of activity from a plurality of robotic bees, wherein the area of activity corresponds to an area where the plurality of robotic bees are instructed to perform various operations, wherein the images of the area of activity comprise the image data of the plant.

13. The computer program product as recited in claim 8, wherein the program code further comprises the programming instructions for:
training a reinforcement learning model to determine an amount of the impulse force to be generated by the robotic bee based on the type of the plant and the classified level of threat.

14. The computer program product as recited in claim 13, wherein a reward is calculated based on a rate of change of a mobility path to a correct mobility path, wherein a penalty is calculated based on damage to the plant.

15. A system, comprising:
a memory for storing a computer program for self-protecting a robotic bee; and
a processor connected to the memory, wherein the processor is configured to execute program instructions of the computer program comprising:
detecting an unbalanced operation of the robotic bee being performed on a plant;
determining a type of the plant using image data of the plant in response to the detected unbalanced operation of the robotic bee;
classifying a level of threat of the robotic bee not being able to complete its requested operation based on received images of the operation of the robotic bee in response to the detected unbalanced operation of the robotic bee; and
instructing the robotic bee to generate an impulse force based on the type of the plant and the classified level of threat.

16. The system as recited in claim 15, wherein the impulse force is generated via a spring.

17. The system as recited in claim 15, wherein the impulse force is generated via compressed air.

18. The system as recited in claim 15, wherein the unbalanced operation of the robotic bee is due to an uneven surface of the plant or a sticky surface of the plant.

19. The system as recited in claim 15, wherein the program instructions of the computer program further comprise:
receiving images of an area of activity from a plurality of robotic bees, wherein the area of activity corresponds to an area where the plurality of robotic bees are instructed to perform various operations, wherein the images of the area of activity comprise the image data of the plant.

20. The system as recited in claim 15, wherein the program instructions of the computer program further comprise:
training a reinforcement learning model to determine an amount of the impulse force to be generated by the robotic bee based on the type of the plant and the classified level of threat.
